(19) United States
(12) Patent Application Publication
(10) Pub. No.: US 2026/0025218 A1
(43) Pub. Date: Jan. 22, 2026

(54) METHOD AND APPARATUS TO SUPPORT TIMER SYNCHRONIZATION AMONG MULTIPLE CHIPS

(71) Applicant: Marvell Asia Pte Ltd, Singapore (SG)

(72) Inventors: Shahe Krakirian, Palo Alto, CA (US); Jason John Bernard Zebchuk, Edinburgh (GB); Sasikumar Parthiban, Livermore, CA (US)

(21) Appl. No.: 19/270,329

(22) Filed: Jul. 15, 2025

Related U.S. Application Data
(60) Provisional application No. 63/673,536, filed on Jul. 19, 2024.

(51) Int. Cl. H04J 3/06

(52) U.S. Cl. CPC H04J 3/0638

(57) ABSTRACT

A new approach is proposed that supports timer synchronization among multiple chips. Under the multi-chip configuration, a secondary timer circuitry of a secondary chip is to be synchronized with a primary timer circuitry of a primary chip. A first secondary timer value is sampled at the secondary timer circuitry as triggered by a first sampling trigger signal when the primary timer circuitry reaches a first primary timer value. A second primary timer value is then sampled at the primary timer circuitry as triggered by a second sampling trigger signal when the secondary timer circuitry reaches a second secondary timer value. A timer correction value is calculated based on the differences between the first primary and secondary timer values and the second primary and secondary timer values. The timer correction value is applied to the secondary timer circuitry to synchronize the primary timer circuitry with the secondary timer circuitry.

### RELATED APPLICATION

This application is a nonprovisional application and claims the benefit and priority to a provisional application No. 63/673,536 that was filed on Jul. 19, 2024, which is incorporated herein by reference in its entirety.

### BACKGROUND

A typical system in a wired or wireless network maintains one or more timers, such as an IEEE Standard 1588-based Precision Time Protocol (PTP) clock/timer and/or a wireless radio frame timer. These timers may be used by a variety of hardware functions, such as time-based scheduling of work and the timestamping of transmitted and received packets. When the hardware functions of the system that use a timer are on the same silicon die/chip, the timer circuitry can be located near those hardware functions. If the hardware functions of the system are on two or more interconnected chips that use the same timer, then each chip must maintain a copy of the timer circuitry for its local consumers. The interconnected chips in question may be connected by interconnect wires and packaged either together in a Multi-Chip Module (MCM) or separately. In general, the portion of the system that is relevant to the timer circuitries may include one or more packages with one or more chips per package.

When multiple chips maintain a copy of the same timer, the copied timers must be synchronized to reflect a consistent time on all chips. Synchronization between the chips must be achieved at an initialization time, and synchronization must be maintained when the timers are adjusted/corrected at run time. A timer on one chip is typically designated as a primary timer (and the chip as the primary chip), and the copies of the timer on other chips are designated as secondary timers (and the chips as the secondary chips). The primary timer is initialized to a value that is in sync with a master timer in the system. The primary timer is also occasionally corrected, typically to eliminate drift from the master timer.

One method to maintain synchronization between chips is to allow the primary chip to periodically transmit its timer value over a chip-to-chip connection (e.g., a serial link) to each other/secondary chip, wherein each secondary chip updates its local timer to match the received timer value. Note that there is a propagation delay over the interconnect wires from the start of transmission of the time value at the primary chip to the end of reception at the secondary chips, wherein the interconnect delay may either be unknown or change over time due to changing operating conditions such as temperature. As a result, any difference between the assumed and actual values of the propagation delay over the interconnect wires will result in a difference/error between the primary and the secondary timer values. Furthermore, if the primary timer is corrected between two consecutive transmission times, the correction will not be reflected at each secondary chip for a period of time during which the primary and secondary timers may have an additional difference.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system to support timer synchronization among multiple chips according to one aspect of the present embodiments.

FIG. 2 depicts an example of block diagram of components within a single chip that are related to each of the primary timer circuitry and the secondary timer circuitries according to one aspect of the present embodiments.

FIG. 3A depicts an example of TCLK synchronization among three chips according to one aspect of the present embodiments, wherein the TCLKs on two chips are sourced from a recovered clock on the other chip; FIG. 3B depicts another example of TCLK synchronization among three chips wherein the TCLKs on all three chips are sourced from the same external clock source according to one aspect of the present embodiments.

FIG. 4 depicts a flowchart of an example of a process to support timer synchronization among multiple chips according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

A new approach is proposed that contemplates a system and method to support timer synchronization among multiple chips. Under the multi-chip configuration, one chip is a primary chip having a primary timer circuitry and the rest of the chips are secondary chips each having a secondary timer circuitry. A first secondary timer value is sampled/captured at the secondary timer circuitry of the secondary chip as triggered by a first sampling trigger signal sent by the primary timer circuitry of the primary chip when the primary timer circuitry reaches a first primary timer value. A second primary timer value is then sampled at the primary timer circuitry as triggered by a second sampling trigger signal sent by the secondary timer circuitry when the secondary timer circuitry reaches a second secondary timer value. A timer correction value is calculated based on the differences between the first primary and secondary timer values and the second primary and secondary timer values. The timer correction value is immediately applied to the secondary timer circuitry to synchronize the primary timer circuitry with the secondary timer circuitry.

By taking signal propagation delays between a pair of chips in both directions into consideration, the proposed approach achieves accurate timer synchronization independent of the signal propagation delays with no delay measurement, calibration or compensation required. Under the proposed approach, the timer circuitries on all chips remain synchronized during timer correction and there is no temporary error between the chips during the timer correction process. As such, consumers of the timer circuitries on all chips see the same timer value at all times, which leads to higher timer accuracy at the system level.

Although interconnected chips are used as non-limiting examples to illustrate the proposed approach of timer synchronization in the discussions hereinafter, the same or similar approach is also applicable to timer synchronization among other types devices, cards, boards and systems that are connected with each other via interconnect wires as understood by one ordinary skilled in the art.

Although three-chip configurations are used as non-limiting examples to illustrate the proposed approach of timer synchronization in the discussions hereinafter, the same or similar approach is also applicable to timer synchronization for any configurations/topologies including two or more chips and is not limited to topologies with three chips as understood by one ordinary skilled in the art. Additionally, the same or similar approach is also applicable to timer synchronization for both homogeneous and heterogeneous chip topologies, including multiple chips of the same type, a mix of chips of different types, and any combination of the two.

Although Serializer/Deserializer (SerDes) unit(s) are used as non-limiting examples of internal unit(s) of a timer circuitry for internal clock generation to illustrate the proposed approach in the discussions hereinafter, the same or similar approach is also applicable to other types of internal units of the timer circuitry for internal clock generation as understood by one ordinary skilled in the art.

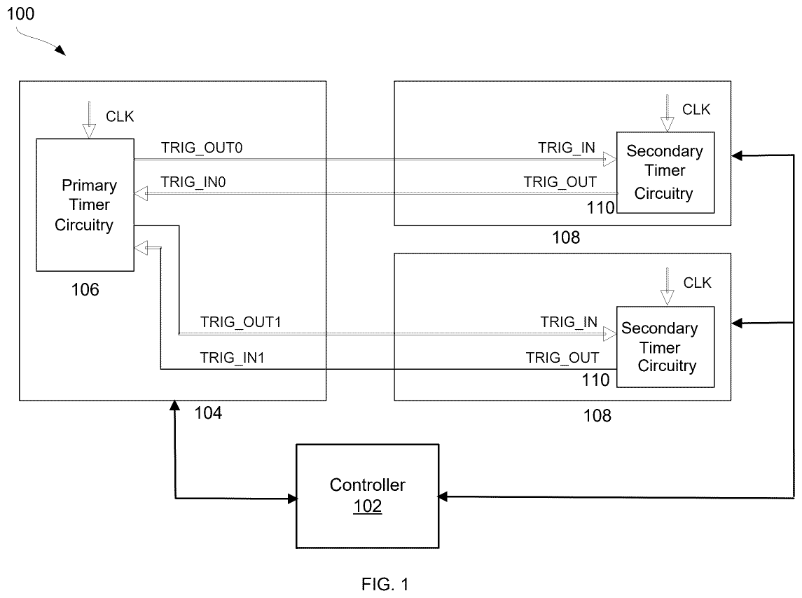

FIG. 1 depicts an example of a diagram of a system 100 to support timer synchronization among multiple chips. Although the diagrams depict components as functionally separate, such depiction is merely for illustrative purposes. It will be apparent that the components portrayed in this figure can be arbitrarily combined or divided into separate software, firmware, and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a controller 102, a primary chip 104 having a primary timer circuitry 106, and one or more secondary chips 108s each having a secondary timer circuitry 110. It is appreciated that each of the controller 102, the primary timer circuitry 106, and the one or more secondary timer circuitries 110s as discussed below may run on one or more chips, computing units or devices each having a processor which can be but is not limited to a CPU, a DPU, a GPU, a TPU, a XPU, or any other type of processing unit or a hardware accelerator with software instructions stored in a storage unit such as a non-volatile memory of the chip or computing unit for practicing one or more processes. When the software instructions are executed by the processor, at least a subset of the software instructions is loaded into memory by one of the computing units, which becomes a special purposed one for practicing the processes. The processes may also be at least partially embodied in the computing units into which computer program code is loaded and/or executed, such that, the computing units become special purpose computing units for practicing the processes.

In some embodiments, the controller 102, the primary timer circuitry 106 and the one or more secondary timer circuitries 110s are configured to communicate with each over a network (not shown) following certain communication protocols such as TCP/IP protocol. Such network can be but is not limited to, internet, intranet, wide area network (WAN), local area network (LAN), wired network, wireless network, Bluetooth, Wi-Fi, mobile communication network, or any other network type.

In some embodiments, the controller 102 is configured to communicate with each of the primary timer circuitry 106 and the one or more secondary timer circuitries 110s via a configuration/status interface (CSI) as discussed below. In some embodiments, the controller 102 can be an external controller that is independent from and outside of the primary chip 104 and/or the one or more secondary chips 108s. In some embodiments, the controller 102 can be an internal component of either the primary chip 104 or one of the one or more secondary chips 108s. In some embodiments, the controller 102 include multiple components distributed among the primary chip 104 and the one or more secondary chips, wherein the distributed components are configured to communicate with each other.

As shown in the example of FIG. 1, the timer circuitry 106 on the primary chip 102 is designated as the primary, wherein the primary timer circuitry 106 serves as a time master in the system 100, while the timer circuitry 110 on each of the secondary chip 104s elsewhere in the system 100 is designated as the secondary, wherein the secondary timer circuitry 110 is to be synchronized to the time master, i.e., the primary timer circuitry 106.

As shown in the example of FIG. 1, the primary timer circuitry 106 is configured to generate and output one or more sampling trigger output signals TRIG_OUT as sampling trigger input signals TRIG_IN to each of the secondary timer circuitries 110s under certain conditions as discussed below. Each of the secondary timer circuitries 110s is also configured to generate and output a sampling trigger output signal TRIG_OUT as one of the sampling trigger input signals TRIG_IN to the primary timer circuitry 106 under certain conditions. In some embodiments, each of the sampling trigger output signals and the sampling trigger input signals is a binary signal, which signal level and/or rising or falling edge may trigger sampling by the timer circuitries as discussed below. In some embodiments, the signal connections, e.g., interconnect wires, between the primary timer circuitry 106 and the secondary timer circuitries 110s are so designed such that the TRIG_OUT to TRIG_IN propagation delay over the interconnect wires in one direction, e.g., from the primary timer circuitry 106 to each secondary timer circuitry 110, matches the propagation delay over the interconnect wires in the opposite direction, e.g., from the each secondary timer circuitry 110 to the primary timer circuitry 106.

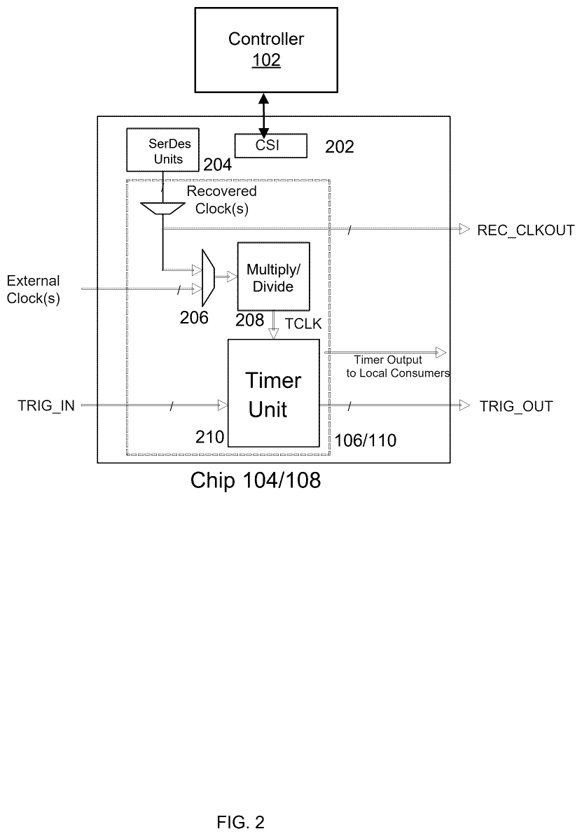

FIG. 2 depicts an example of block diagram of components on a single chip 104 or 108 that are related to each of the primary timer circuitry 106 and the secondary timer circuitries 108s. As shown in the example of FIG. 2, each chip 104 or 108 includes a CSI 202 coupled to and configured to support communication between the controller 102 and each timer circuitry 106/110. For example, the CSI 202 is configured to read status/values of the timer circuitry 106/110 to the controller 102 and to write configurations, e.g., time values, from the controller 102 to the timer circuitry 106/110. In some embodiments, The CSI 202 is controlled by one or more processor cores and/or state machines either running on the each chip 104 or 108 or external to the each chip 104 or 108, for example, a Joint Test Action Group (JTAG) interface attached to an external debugger.

In some embodiments, each timer circuitry 106/110 is configured to receive one or more external clocks and/or one or more internal/recovered clocks from one or more internal units such as SerDes units 204 of the timer circuitry 106/110. Here, each recovered clock is an internal clock signal that is extracted from a received data stream and can be used for synchronizing timer circuitries of the chips. In some embodiments, each timer circuitry 106/110 includes one or more multiplexers 206s, each configured to accept the external and/or recovered clocks as its inputs and to select one of the external and/or recovered clocks as its output. The multiplexers 206s are only needed if more than one clock input (external and/or recovered) is present.

In some embodiments, each timer circuitry 106/110 includes an optional clock multiply/divide unit 208 configured to accept the selected clock from the multiplexer 206 as its input, and generate a timer clock (TCLK) for a timer unit 210 of the each timer circuitry 106/110. In some embodiments, the clock multiply/divide unit 208 includes a sequence of clock dividers and/or multipliers (in any order) configured to generate the TCLK at a higher frequency than the input clock. The higher frequency TCLK enables the timer unit 210 to generate its timer value more frequently and thus improves accuracy of the timer unit 210. For example, the clock multiply/divide unit 208 may divide a 156.25 MHz input clock by 5 and then multiply it by 32 to produce a 1000 MHz TCLK so that the timer value advances every Ins instead of every 6.4 ns. If the clock multiply/divide unit 208 is not present (or is present and bypassed by the CSI 202), then the selected input clock by the multiplexer 206 is used directly as TCLK to the timer unit 210.

In the example of FIG. 2, the timer unit 210 of each timer circuitry 106/110 may be implemented using one or more counters and the timer unit 210 takes TCLK as its input and advances by a configurable value every TCLK cycle. In some embodiments, a first counter of the timer unit 210 counts nanoseconds and a second counter counts seconds. In some embodiments, the first nanosecond counter may also include bits which count a fraction of a nanosecond for increased accuracy. In some embodiments, the timer unit 210 may track frames in a radio network and include one or more of a frame counter, a subframe counter, and a tick counter that counts the number of TCLK cycles per subframe over a certain period of time, e.g., 10 ms.

In some embodiments, the timer unit 210 is configured to run on a different clock, e.g., SCLK, which is a generic/system clock that is synchronous to other surrounding blocks/functions in the chip 104 or 108. In some embodiments, frequency of SCLK is higher than the frequency of TCLK. In some embodiments, the rising edge, falling edge or both edges of TCLK are synchronized to SCLK, wherein the timer unit 210 advances by a configurable value on every synchronized TCLK edge detected as discussed above.

In some embodiments, the controller 102 is configured to correct the timer unit 210 by a programmable timer correction value Tcorr, either immediately or at a programmable future update time Tupdate. Here, Tcorr may be either a positive value to advance the timer unit 210 or a negative value to roll back the timer unit 210. In some embodiments, the controller 102 is configured to program Tcorr and Tupdate typically via CSI 202. In some embodiments, the controller 102 is configured to adopt a gradual correction option, wherein a programmable correction step value Tstep specifies the maximum amount by which the timer unit 210 is corrected every N TCLK cycles, where N is a positive integer. In some embodiments, both Tstep and N may be programmed by the controller 102 using CSI 202. When the timer correction is triggered (either immediately or at specified time Tupdate), the controller 102 executes the timer correction in Tcorr/Tstep steps (rounded up to the nearest integer) that are N TCLK cycles apart if Tcorr is greater than Tstep. The correction amount applied on each step (with the possible exception of the last step) will be Tstep. If Tcorr is not an integer multiple of Tstep, then the correction applied on the last step will be the remaining fraction of Tstep. If Tcorr is less than Tstep, the correction is executed as a single step.

As shown in the example of FIG. 2, the timer unit 210 outputs a timer value, which is used by local consumers of the timer on the chip 104 or 108. The timer unit 210 also accepts one or more sampling trigger input signals TRIG_IN, each of which triggers sampling of the timer value of the timer unit 210 on TRIG_IN's rising edge, falling edge, or both. The timer unit 210 further generates one or more sampling trigger output signals TRIG_OUT, each of which includes a pulse or transition at a configured time, i.e., at a configured timer value of the timer unit 210. In some embodiments, the timer unit 210 also generates and outputs one or more optional recovered clock output signals REC_CLKOUT, which output a selected recovered clock from the SerDes unit 204. In some embodiments, each of the input and output signals described above (e.g., external clocks, TRIG_IN, TRIG_OUT, REC_CLKOUT) may be mapped to a fixed package I/O signal or a programmable general purpose I/O signal (GPIO) of the chip 104 or 108. Additionally, each I/O signal, whether fixed or programmable, may be single-ended or differential.

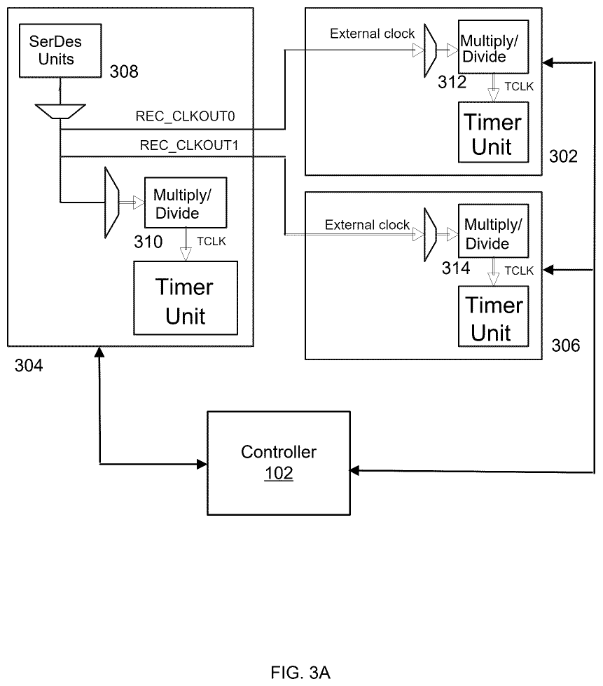

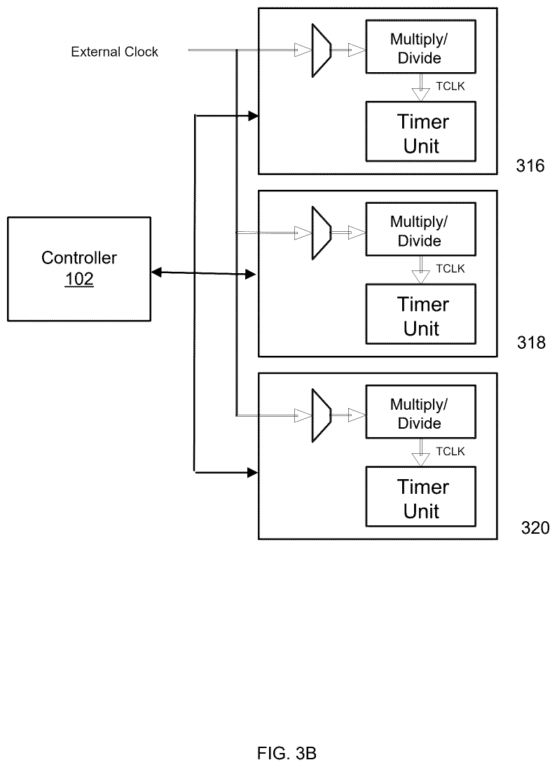

In order to synchronize the timer circuitries on chips 104 and 108s, the local timer clocks (TCLKs) on the chips 104 and 108s must run at the same frequency. The TCLKs must also be generated from the same source clock (external or recovered) in order to remain in lockstep and prevent the TCLKs from drifting relative to each other over time. FIG. 3A depicts an example of TCLK synchronization among three chips labeled as chip 302, 304, and 306. As shown in the example of FIG. 3A, a recovered clock generated from a SerDes unit 308 of chip 304 is used as the source for the TCLKs on all three chips. The SerDes recovered clock is used where a reference clock (or a derivative thereof) is transferred over a serial data link such as Synchronous Ethernet (SyncE). In the example of FIG. 3A, a designated SerDes lane in chip 306 that is associated with a serial data link (such as Ethernet) receives data from a link partner which transmits the data at a rate derived from the reference clock. Thus, the recovered clock on chip 304 will be derived from the link partner's reference clock.

In the example of FIG. 3A, REC_CLKOUT0 and REC_CLKOUT1 signals from chip 304 are provided as external clock inputs to chips 302 and 306, respectively. Alternatively, a single REC_CLKOUT from chip 304 may be provided as external clock input to both chips 302 and 306. In some embodiments, the controller 102 is configured to program the chips 302, 304, and 306 via the CSIs on each of the chips. Specifically, REC_CLKOUT0 and REC_CLKOUT1 of chip 304 are the recovered clock of a selected SerDes lane, which is also selected as the input clock to the optional multiplier/divider 310 on chip 304. The external clock of chip 302 and chip 306 attached to the REC_CLKOUT0/1 from chip 304 is selected as the input clock to the optional multiplier/dividers 312 and 314 on chips 302 and 304, respectively, wherein the multiply/divide units 310, 312, and 314 on the three chips 302, 304, and 306 are configured identically. As a result, the TCLKs on all three chips 302, 304, and 306 will be in lockstep, i.e., they will be sourced from the same recovered clock from the SerDes unit 308 on chip 304 and run at the same frequency. FIG. 3B depicts another example of TCLK synchronization among three chips labeled as chip 316, 318, and 320, respectively, wherein the TCLKs on all three chips are sourced from the same external clock source and are configured/programmed by the controller 102 to run at the same frequency.

It is appreciated that the three chips in FIGS. 3A and 3B may be connected in such way to support multiple options for selecting the same source clock and to allow the CSIs on the chips to select one of the options. For example, the options to be selected by the CSIs can be either a recovered SerDes clock from any of the three chips or an external clock as discussed above. Alternatively, the connections via interconnect wires and configurations of the chips for TCLK generation may be fixed in hardware and not require configuration/programming with the CSIs on each chip. In general, any combination of fixed and configurable/programmable selections can be utilized for TCLK generation among multiple chips.

Once the timer circuitries on the different chips 104 and 108s are running at the same TCLK frequency derived from a common source clock, the controller 102 is configured to synchronize the secondary timer circuitry 110 on each secondary chip 108 to the primary timer circuitry 106 on the primary chip 102 using the sampling trigger signals TRIG_IN and TRIG_OUT either via software or a hardware state machine.

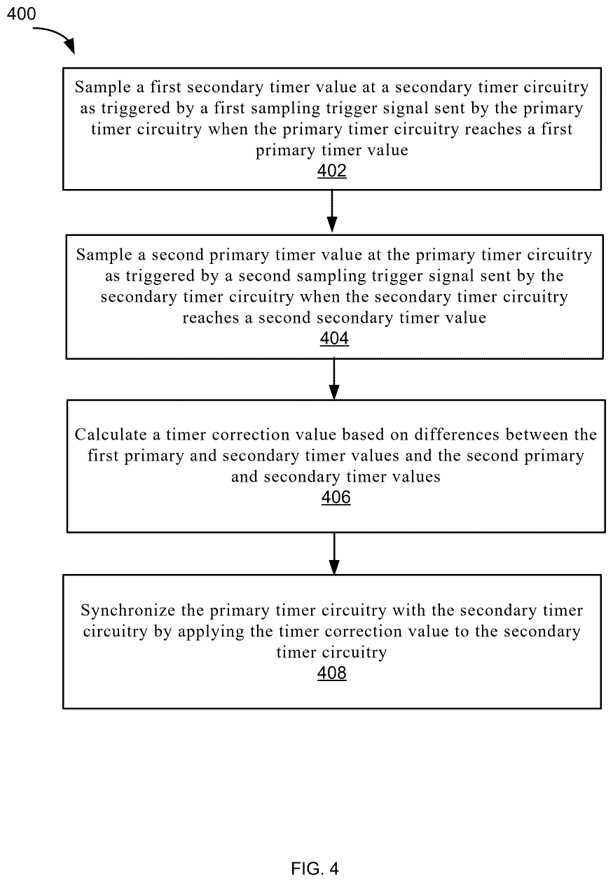

FIG. 4 depicts a flowchart 400 of an example of a process to support timer synchronization among multiple chips. Although the figure depicts functional steps in a particular order for purposes of illustration, the processes are not limited to any particular order or arrangement of steps. One skilled in the relevant art will appreciate that the various steps portrayed in this figure could be omitted, rearranged, combined, and/or adapted in various ways.

In the example of FIG. 4, the flowchart 400 starts at block 402, where a first secondary timer value is sampled/captured at the secondary timer circuitry 110 as triggered by a first sampling trigger signal sent by the primary timer circuitry 106 when the primary timer circuitry 106 reaches a first primary timer value. Specifically, the controller 102 configures the secondary timer circuitry 110 to capture its timer value t2 (i.e., the first secondary time value) upon receiving the first sampling trigger signal as a sampling trigger input signal TRIG_IN. The controller 102 also configures the primary timer circuitry 106 to generate the first sampling trigger signal as a sampling trigger output signal TRIG_OUT when its timer value reaches time t1 (i.e., the first primary timer value) in the future. Alternatively, the controller 102 configures the primary timer circuitry 106 to immediately generate the first sampling trigger output signal TRIG_OUT and to record the time (t1) at which TRIG_OUT is generated as the first primary timer value. At time t1, the primary timer circuitry 106 sends the sampling trigger output signal TRIG_OUT as the sampling trigger input signal TRIG_IN (i.e., the first sampling trigger signal) to the secondary timer circuitry 110, which then samples/captures its timer value t2. The controller 102 then collects/reads both the first primary timer value t1 and the first secondary timer value t2 from the primary timer circuitry 106 and the secondary timer circuitry 110, respectively.

The flowchart 400 continues to block 404, where a second primary timer value is sampled/captured at the primary timer circuitry 106 as triggered by a second sampling trigger signal sent by the secondary timer circuitry 110 when the secondary timer circuitry 110 reaches a second secondary timer value. Specifically, the controller 102 configures the primary timer circuitry 106 to capture its timer value (i.e., the second primary time value) t4 upon receiving the second sampling trigger signal as a sampling trigger input signal TRIG_IN. The controller 102 also configures the secondary timer circuitry 110 to generate the second sampling trigger signal as a sampling trigger output signal TRIG_OUT when its timer value reaches time t3 (i.e., the second secondary timer value) in the future. At time t3, the secondary timer circuitry 110 sends the sampling trigger output signal TRIG_OUT as the sampling trigger input signal TRIG_IN (i.e., the second sampling trigger signal) to the primary timer circuitry 106, which then samples/captures its timer value t4. The controller 102 then collects/reads both the second primary timer value and the second secondary timer value from the primary timer circuitry 106 and the secondary timer circuitry 110, respectively.

The flowchart 400 continues to block 406, where a timer correction value Tcorr is calculated by the controller 102 based on differences between the first primary and secondary timer values and the second primary and secondary timer values as follows:

Tcorr=(t1−t2+t4−t3)/2

wherein the timer correction value Tcorr may be either positive or negative. Here, the differences between the primary and secondary timer values are caused by propagation delays over the interconnect wires between the primary and the secondary timer circuitries.

The flowchart 400 ends at block 408, where the primary timer circuitry 106 is synchronized with the secondary timer circuitry 110 by the controller 102 by applying the timer correction value Tcorr to the secondary timer circuitry 110.

It is appreciated that in the steps of the flowchart 400 discussed above, the controller 102 communicates with (e.g., configures, reads, corrects, etc.) the primary timer circuitry 106 with the secondary timer circuitry 110 via the respective CSIs 202s on the primary chip 104 and the secondary chip 108, respectively.

It is appreciated that a TRIG_IN/TRIG_OUT pair of signals may be present between any pair of chips in FIG. 1, e.g., between the two secondary chips 108, which allows any of the three chips in FIG. 1 to be dynamically selected as the primary while the other two chips as secondaries.

In some embodiments, it is also possible to reduce the number of signals and interconnect wires between the chips by using programmable GPIOs. For each pair of chips, a GPIO on one chip can be programmed/configured as TRIG_IN or TRIG_OUT and vice versa on the other chip. For example, in the flowchart described above, the GPIO on the primary chip 104 can be configured as TRIG_OUT in block 402 and TRIG_IN in block 404, and vice versa for the secondary chip 108. Using the same GPIO pair in both directions reduces the number of synchronization signals between the chips and makes it easier to match the TRIG_IN to TRIG_OUT propagation delays in the two directions.

In some embodiments, the timer circuitries on each chip may need to be occasionally corrected, e.g., to correct drift from a master timer in the system 100 as discussed above. In some embodiments, the controller 102 is configured to correct the timer circuitries on all chips by a correction time Tcorr as follows:
Select an update time Tupdate in the future when the timer circuitries on all chips are to be updated.
Configure the timer circuitry on each chip to be corrected by Tcorr at time Tupdate.
Simultaneously correct the timer circuitries on all chips by the correction time Tcorr to a new time at time Tupdate.

If the gradual correction option described above is adopted, then the timer circuitries on all chips are corrected identically over Tcorr/Tstep steps. As a result, the timer circuitries will remain synchronized before, during and after the correction.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system, comprising:
a controller configured to
sample a first secondary timer value at a secondary timer circuitry of a secondary chip as triggered by a first sampling trigger signal sent by a primary timer circuitry of a primary chip when the primary timer circuitry reaches a first primary timer value, wherein the secondary timer circuitry of the secondary chip is to be synchronized with the primary timer circuitry of the primary chip;
sample a second primary timer value at the primary timer circuitry as triggered by a second sampling trigger signal sent by the secondary timer circuitry when the secondary timer circuitry reaches a second secondary timer value;
calculate a timer correction value based on differences between the first primary and secondary timer values and the second primary and secondary timer values; and
synchronize the primary timer circuitry with the secondary timer circuitry by applying the timer correction value to the secondary timer circuitry.

2. The system of claim 1, wherein:
the controller is configured to communicate with each of the primary timer circuitry and the secondary timer circuitry via a configuration/status interface (CSI) of the each of the primary timer circuitry and the secondary timer circuitry.

3. The system of claim 1, wherein:
the controller is an external controller that is independent from and outside of the primary chip and/or the secondary chip.

4. The system of claim 1, wherein:
the controller is an internal component of either the primary chip or the secondary chip.

5. The system of claim 1, wherein:
the controller is distributed among the primary chip and the secondary chip.

6. The system of claim 1, wherein:
the controller is configured to
configure the secondary timer circuitry to capture the first secondary time value upon receiving the first sampling trigger signal;
configure the primary timer circuitry to generate the first sampling trigger signal when the first primary timer value is reached; and
collect both the first primary timer value and the first secondary timer value from the primary timer circuitry and the secondary timer circuitry, respectively.

7. The system of claim 1, wherein:
the controller is configured to
configure the secondary timer circuitry to capture the first secondary time value upon receiving the first sampling trigger signal;
configure the primary timer circuitry to generate the first sampling trigger signal immediately and record the current time as the first primary timer value; and
collect both the first primary timer value and the first secondary timer value from the primary timer circuitry and the secondary timer circuitry, respectively.

8. The system of claim 1, wherein:
the controller is configured to
configure the primary timer circuitry to capture the second primary time value upon receiving the second sampling trigger signal;
configure the secondary timer circuitry to generate the second sampling trigger signal when the second secondary timer value is reached; and
collect both the second primary timer value and the second secondary timer value from the primary timer circuitry and the secondary timer circuitry, respectively.

9. The system of claim 1, wherein:
the first sampling trigger signal and/or the second sampling trigger signal are communicated between the primary timer circuitry and the secondary timer circuitry as a programmable general purpose I/O signal (GPIO).

10. The system of claim 1, wherein:
the controller is configured to correct the primary timer circuitry and/or the second timer circuitry by a programmable correction time, wherein the primary timer circuitry and the second timer circuitry remain synchronized before, during and after the correction.

11. The system of claim 1, wherein:
each of the primary timer circuitry and the secondary timer circuitry is configured to receive one or more external clocks and/or one or more recovered clocks from one or more internal units.

12. The system of claim 11, wherein:
each of the primary timer circuitry and the secondary timer circuitry includes a clock multiply/divide unit configured to accept one of the one or more clocks as its input, and generate a timer clock (TCLK) for the each of the primary timer circuitry and the secondary timer circuitry.

13. The system of claim 12, wherein:
each of the primary timer circuitry and the secondary timer circuitry is configured to run on a generic clock different from the TCLK, wherein the generic clock is synchronous to other surrounding blocks/functions in the primary chip and the secondary chip.

14. The system of claim 12, wherein:
the TCLKs of the primary timer circuitry and the secondary timer circuitry are generated from a same clock and run in lockstep at the same frequency.

15. The system of claim 14, wherein:
the same clock is either a recovered clock from any of the primary and secondary chips or an external clock.

16. A method, comprising:
sampling a first secondary timer value at a secondary timer circuitry of a secondary chip as triggered by a first sampling trigger signal sent by a primary timer circuitry of a primary chip when the primary timer circuitry reaches a first primary timer value, wherein the secondary timer circuitry of the secondary chip is to be synchronized with the primary timer circuitry of the primary chip;
sampling a second primary timer value at the primary timer circuitry as triggered by a second sampling trigger signal sent by the secondary timer circuitry when the secondary timer circuitry reaches a second secondary timer value;
calculating a timer correction value based on differences between the first primary and secondary timer values and the second primary and secondary timer values; and
synchronizing the primary timer circuitry with the secondary timer circuitry by applying the timer correction value to the secondary timer circuitry.

17. The method of claim 16, further comprising:
communicating with each of the primary timer circuitry and the secondary timer circuitry via a configuration/status interface (CSI) of the each of the primary timer circuitry and the secondary timer circuitry.

18. The method of claim 16, further comprising:
configuring the secondary timer circuitry to capture the first secondary time value upon receiving the first sampling trigger signal;
configuring the primary timer circuitry to generate the first sampling trigger signal when the first primary timer value is reached; and
collecting both the first primary timer value and the first secondary timer value from the primary timer circuitry and the secondary timer circuitry, respectively.

19. The method of claim 16, further comprising:
configuring the secondary timer circuitry to capture the first secondary time value upon receiving the first sampling trigger signal;
configuring the primary timer circuitry to generate the first sampling trigger signal immediately and record the current time as the first primary timer value; and
collecting both the first primary timer value and the first secondary timer value from the primary timer circuitry and the secondary timer circuitry, respectively.

20. The method of claim 16, further comprising:
configuring the primary timer circuitry to capture the second primary time value upon receiving the second sampling trigger signal;
configuring the secondary timer circuitry to generate the second sampling trigger signal when the second secondary timer value is reached; and
collecting both the second primary timer value and the second secondary timer value from the primary timer circuitry and the secondary timer circuitry, respectively.

21. The method of claim 16, further comprising:
communicating the first sampling trigger signal and/or the second sampling trigger signal between the primary timer circuitry and the secondary timer circuitry as a programmable general purpose I/O signal (GPIO).

22. The method of claim 16, further comprising:
correcting the primary timer circuitry and/or the second timer circuitry by a programmable correction time, wherein the primary timer circuitry and the second timer circuitry remain synchronized before, during and after the correction.

23. The method of claim 16, further comprising:
receiving one or more external clocks and/or one or more recovered clocks from one or more internal units of each of the primary timer circuitry and the secondary timer circuitry.

24. The method of claim 23, further comprising:
generating a timer clock (TCLK) for the each of the primary timer circuitry and the secondary timer circuitry based on the one of the one or more clocks.

25. The method of claim 24, further comprising:
running each of the primary timer circuitry and the secondary timer circuitry on a generic clock different from the TCLK, wherein the generic clock is synchronous to other surrounding blocks/functions in the primary chip and the secondary chip.

26. The method of claim 24, further comprising:
generating the TCLKs of the primary timer circuitry and the secondary timer circuitry from a same clock and run in lockstep at the same frequency, wherein the same clock is either a recovered clock from any of the primary and secondary chips or an external clock.

27. A system, comprising:
a means for sampling a first secondary timer value at a secondary timer circuitry of a secondary chip as triggered by a first sampling trigger signal sent by a primary timer circuitry of a primary chip when the primary timer circuitry reaches a first primary timer value, wherein the secondary timer circuitry of the secondary chip is to be synchronized with the primary timer circuitry of the primary chip;
a means for sampling a second primary timer value at the primary timer circuitry as triggered by a second sampling trigger signal sent by the secondary timer circuitry when the secondary timer circuitry reaches a second secondary timer value;
a means for calculating a timer correction value based on differences between the first primary and secondary timer values and the second primary and secondary timer values; and
a means for synchronizing the primary timer circuitry with the secondary timer circuitry by applying the timer correction value to the secondary timer circuitry.
